(19) United States
(12) Patent Application Publication
(10) Pub. No.: US 2007/0006659 A1
(43) Pub. Date: Jan. 11, 2007

(54) System and method for directional vibration measurement

(75) Inventors: Aaron Schwartzbart, Winnetka, CA (US); Robert Nelson, Tujunga, CA (US)

Correspondence Address: INGRASSIA FISHER & LORENZ, P.C., 7150 E. CAMELBACK, STE. 325, SCOTTSDALE, AZ, 85251, US

(73) Assignee: The Boeing Company

(21) Appl. No.: 11/179,115

(22) Filed: Jul. 11, 2005

(51) Int. Cl. G01H 11/00

(52) U.S. Cl. 73/649

(57) ABSTRACT

A directional vibration measurement system as described herein includes a magnetic element coupled to a vibrating component, at least two magnetic induction sensors configured to generate sensor signals in response to movement of the magnetic element, and a controller/processor coupled to the sensors for obtaining and processing the sensor signals. The sensors are positioned such that the direction of vibration can be resolved by analyzing and processing the sensor signals. In one example embodiment, the phase relationship between the sensor signals is analyzed to determine the extent of vibration in a first direction and the extent of vibration in a second direction. In another example embodiment, the directional vibration measurement system generates sum and difference signals based upon the sensor signals, and the sum and difference signals are analyzed to determine the extent of vibration in a first direction and the extent of vibration in a second direction.

### TECHNICAL FIELD

The present invention relates generally to vibration measurement systems. More particularly, the present invention relates to a magnetic induction based vibration measurement system that is capable of determining directional vibration states of a vibrating component.

### BACKGROUND

The prior art is replete with vibration measurement and detection systems that are deployed to measure vibration of various components of interest. For example, vibration measurement systems can be utilized in aircraft, aerospace, and other applications to measure the vibration of components such as engines, rockets, turbines, and the like. In some applications the target component is an internal structure that is surrounded or shielded by an outer housing or other structure that makes it impractical to directly measure the vibration of the target component. In such applications, the vibration of the outer housing or structure can be measured, assuming that the vibration of the target component is transferred to the outer housing or structure. Such indirect methods of measuring vibration, however, may not be desirable for some applications. For example, such indirect methods of measuring vibration are inherently limited in their fidelity to the extent that the vibration of multiple internal components is attenuated, amplified, filtered, obscured, and/or mixed mechanically as the vibration is transmitted mechanically through the housing to the externally-mounted vibration sensor.

Some proposed vibration measurement systems may be designed to only provide a vibration magnitude and/or a vibration frequency for the target component. While such limited information may be adequate for many applications, other applications might require additional information such as the directional state(s) of the vibration. One practical approach to directional vibration measurement requires multiple vibration sensors, each being designed to measure vibration in a single direction. Consequently, this approach requires additional components and duplicative processing to achieve directional vibration measurement.

Accordingly, it is desirable to have a vibration measurement system that can directly measure the vibration of a target component, even if the target component is mounted within an outer housing. Furthermore, other desirable features and characteristics of the present invention will become apparent from the subsequent detailed description and the appended claims, taken in conjunction with the accompanying drawings and the foregoing technical field and background.

### BRIEF SUMMARY

A system for measuring vibration of a component as described herein is capable of measuring the direction of vibration of an internal component that is surrounded by an outer housing. The system employs techniques such that no physical connection need be established between the vibrating internal component and sensors located on or outside the outer housing. The system utilizes signal processing algorithms that determine the magnitude and direction of vibration of the internal component.

The above and other aspects of the invention may be carried out in one form by a method for measuring directional vibration states of a component. The method involves obtaining a first magnetically induced sensor signal generated in response to vibration of a magnetic element coupled to the component, obtaining a second magnetically induced sensor signal generated in response to vibration of the magnetic element, and processing the first and second sensor signals to determine at least a first vibration state of the component corresponding to a first direction of motion, and a second vibration state of the component corresponding to a second direction of motion.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic representation of a vibration measurement system configured in accordance with an example embodiment of the invention;

FIG. 2 is a schematic block diagram representation of a vibration measurement system configured in accordance with an example embodiment of the invention;

FIG. 3 is a diagram that illustrates a first direction of vibration of a target component relative to two vibration sensors;

FIG. 4 is a diagram that illustrates a second direction of vibration of a target component relative to two vibration sensors;

FIG. 5 is a schematic representation of processing elements for a controller/processor suitable for use in the vibration measurement system shown in FIG. 2;

FIG. 6 is a schematic representation of processing elements for another controller/processor suitable for use in the vibration measurement system shown in FIG. 2;

FIG. 7 includes graphs of two example vibration sensor signals corresponding to the first direction of vibration depicted in FIG. 3;

FIG. 8 is a graph of a signal that represents the sum of the vibration sensor signals shown in FIG. 7;

FIG. 9 is a graph of a signal that represents the difference of the vibration sensor signals shown in FIG. 7;

FIG. 10 includes graphs of two example vibration sensor signals corresponding to the second vibration direction depicted in FIG. 4;

FIG. 11 is a graph of a signal that represents the sum of the vibration sensor signals shown in FIG. 10;

FIG. 12 is a graph of a signal that represents the difference of the vibration sensor signals shown in FIG. 10;

FIG. 13 is a schematic representation of a two-sensor vibration measurement system configured in accordance with an example embodiment of the invention;

FIG. 14 is a schematic representation of a three-sensor vibration measurement system configured in accordance with an example embodiment of the invention;

FIG. 15 is a schematic representation of an eight-sensor vibration measurement system configured in accordance with an example embodiment of the invention;

FIG. 16 is a flow chart of a directional vibration measurement process according to an example embodiment of the invention;

FIG. 17 is a flow chart of phase-based processing that may be performed in connection with the directional vibration measurement process shown in FIG. 16; and

FIG. 18 is a flow chart of signal combination based processing that may be performed in connection with the directional vibration measurement process shown in FIG. 16.

### DETAILED DESCRIPTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be deployed in any number of practical environments.

For the sake of brevity, conventional techniques related to magnetically-induced current/voltage, magnetism, signal processing, and other functional aspects of the systems (and the individual operating components of the systems) may not be described in detail herein. Furthermore, the connecting lines shown in the various figures contained herein are intended to represent example functional relationships and/or physical couplings among the various elements. It should be noted that many alternative or additional functional relationships or physical connections may be present in a practical embodiment.

The following description refers to elements or features being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the figures might depicts example arrangements of elements, additional intervening elements, devices, features, or components may be present in an actual embodiment (assuming that the functionality of the system or subsystem is not adversely affected).

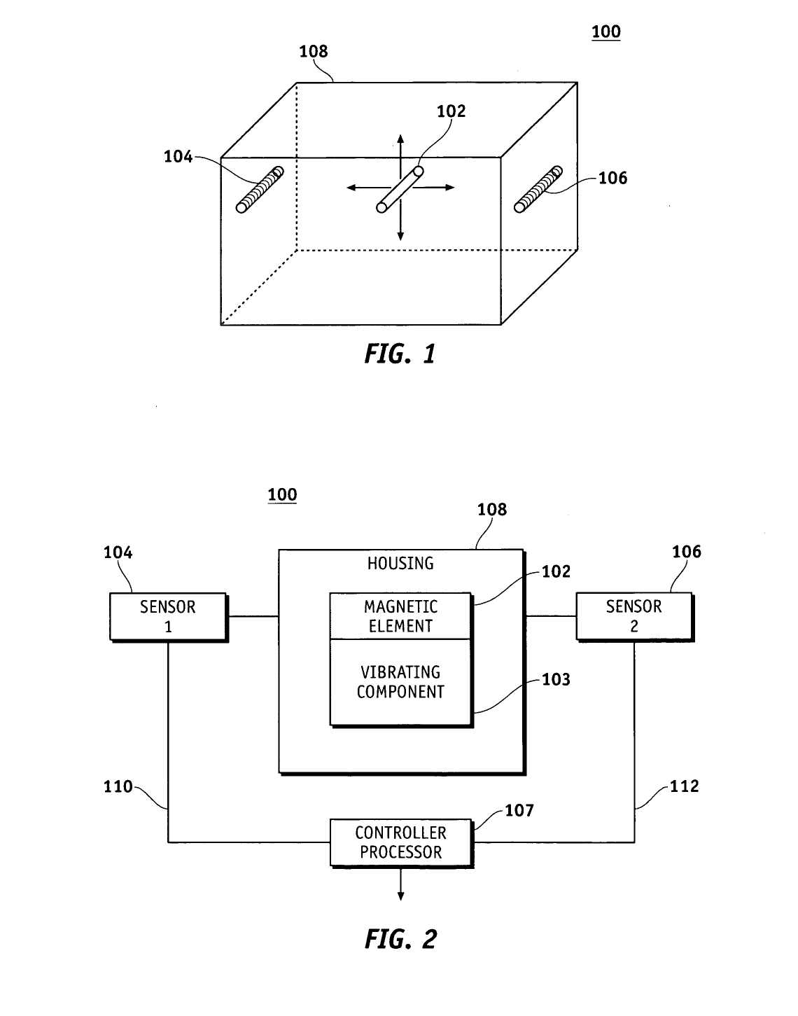

FIG. 1 is a schematic representation of a vibration measurement system 100 configured in accordance with an example embodiment of the invention, and FIG. 2 is a schematic block diagram representation of vibration measurement system 100. System 100 generally includes a magnetic element 102 coupled to a vibrating component 103, a first induction coil sensor 104, a second induction coil sensor 106, and a controller/processor 107 coupled to first and second induction coil sensors 104/106. First induction coil sensor 104 preferably has a first fixed position, and second induction coil sensor 106 preferably has a second fixed position. For the practical deployment described herein, component 103 is an internal component contained within a housing 108, magnetic element 102 is coupled to component 103, first induction coil sensor 104 is coupled to housing 108, and second induction coil sensor 106 is coupled to housing 108. As depicted in FIG. 1, magnetic element 102 may be located between first induction coil sensor 104 and second induction coil sensor 106. Alternatively, the nominal position of magnetic element 102 may be parallel with, but axially offset from, first induction coil sensor 104 and second induction coil sensor 106.

Component 103 may vibrate within housing 108 while housing 108 remains stationary. In practical embodiments where housing 108 itself might vibrate, first and second induction coil sensors 104/106 need not be mounted to housing 108. System 100 is suitably configured to measure the direction of vibration of component 103 without requiring mechanical or electrical connections between magnetic element 102 and either of first or second induction coil sensors 104/106. Briefly, magnetic element 102 includes a magnetic material that produces a magnetic field (magnetic flux) that penetrates housing 108 and interacts with first and second induction coil sensors 104/106. In this regard, first and second induction coil sensors 104/106 may be considered to be magnetic field sensors. Sensors 104/106 directly sense the vibration of component 103 via electromagnetic coupling with magnetic element 102 rather than relying on mechanical coupling from component 103 to housing 108. In operation, first induction coil sensor 104 provides a first magnetically induced sensor signal in response to vibration of magnetic element 102—such vibration results in a changing magnetic field proximate to first induction coil sensor 104 that, in turn, induces an electrical current within first induction coil sensor 104. Likewise, second induction coil sensor 106 provides a second magnetically induced sensor signal in response to vibration of magnetic element 102.

In a practical embodiment, magnetic element 102 may be realized as a piece of ferromagnetic material, having a high retained magnetization (e.g., a “permanent magnet”), that is hermetically sealed within a protective casing that protects the magnetic material from potentially harsh environmental conditions. The protective casing may resemble a threaded bolt, a screw, or a threaded pin, which allows magnetic element 102 to be directly attached to component 102 if needed. In the example embodiment described herein, magnetic element 102 is cylindrical in shape, it has a longitudinal axis corresponding to its cross sectional center point, and it has a north pole and a south pole. The actual shape, size, cross sectional configuration, and magnetic characteristics of magnetic element 102 will depend upon the requirements of the particular application.

Each of the first and second sensors 104/106 may be configured as a conventional magnetic induction coil sensor. Such sensors are commercially available for use in conventional rotational speed measurement systems. In this regard, each of the first and second sensors 104/106 may include a ferromagnetic core wound by a conductive wire. Each of the first and second sensors 104/106 is suitably configured such that, in response to a change in magnetic field near the sensor, current is induced in the core winding. The core winding is coupled to controller/processor 107 to enable controller/processor 107 to receive and process the respective sensor signals. In the example embodiment described herein, the ferromagnetic core in each of the first and second sensors 104/106 is cylindrical in shape, with a longitudinal axis corresponding to its cross sectional center point. As depicted in FIG. 1, the longitudinal axis of magnetic element 102 is nominally parallel to the core longitudinal axis of first sensor 104 and nominally parallel to the core longitudinal axis of second sensor 106. This arrangement fosters efficient operation of vibration measurement system 100. The actual shape, size, cross sectional configuration, and magnetic characteristics of each of the first and second sensors 104/106 will depend upon the requirements of the particular application.

In a practical embodiment, controller/processor 107, which may be realized with hardware, software, firmware, logic components, or any combination thereof, may employ any number of signal processing algorithms that are suitably configured to analyze the sensor signals generated by first and second sensors 104/106. In particular, controller/processor 107 may be configured to perform the various analytical, computational, quantifying, and other tasks that support the operation of vibration measurement system 100 as described in more detail herein. For example, controller/processor 107 obtains and processes a first magnetically induced voltage signal 110 generated by first induction coil sensor 104 and a second magnetically induced voltage signal 112 generated by second induction coil sensor 106. Controller/processor 107 is suitably configured to process first and second sensor signals 110/112 to determine at least a first vibration state of component 103, which corresponds to a first direction of motion, and a second vibration state of component 103, which corresponds to a second direction of motion.

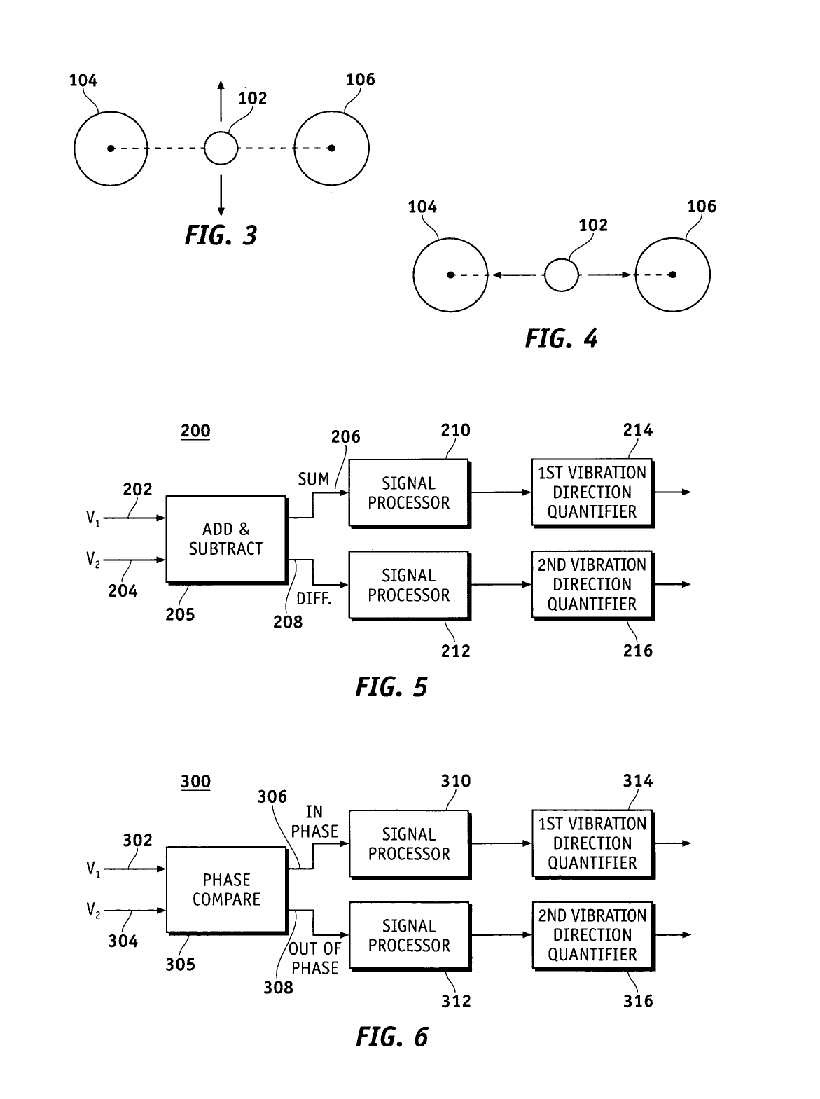

For the simplified example described herein, the first direction of motion is represented by the vertical arrows in FIG. 1, and the second direction of motion is represented by the horizontal arrows in FIG. 1. In other words, the first vibration state corresponds to a direction of motion perpendicular to an imaginary line or plane drawn between the longitudinal axis of the core used by first induction coil sensor 104 and the longitudinal axis of the core used by second induction coil sensor 106, while the second vibration state corresponds to a direction of motion along that imaginary line or plane. FIG. 3 is a side view diagram that illustrates the first vibration state of magnetic element 102 relative to first and second sensors 104/106, and FIG. 4 is a side view diagram that illustrates the second vibration state of magnetic element 102 relative to first and second sensors 104/106. The dashed line in FIG. 3 and FIG. 4 represents the imaginary line between the longitudinal axes of the sensor cores. The vibration of magnetic element 102 need not be restricted to these two directions and, in practice, magnetic element 102 might be free to vibrate in any direction within a three dimensional space.

Controller/processor 107 (see FIG. 2) may be configured to perform phase-based processing of the received sensor signals and/or signal combination based processing of the received sensor signals. Thus, controller/processor 107 may be realized using different configurations depending upon the practical deployment of vibration measurement system 100. For example, FIG. 5 is a schematic representation of processing elements for a controller/processor 200, where the processing elements are configured to perform the signal combination techniques described herein. In contrast, FIG. 6 is a schematic representation of processing elements for a controller/processor 300, where the processing elements are configured to perform the phase-based techniques described herein. Of course, a practical controller/processor 107 may be configured to support both techniques.

Referring to FIG. 5, processor/controller 200 receives a first voltage signal 202 associated with first sensor 104, and a second voltage signal 204 associated with second sensor 106. An add and subtract element 205 generates a sum 206 and a difference 208 of first and second voltage signals 202 and 204. In this example, difference 208 is generated by subtracting second voltage signal 204 from first voltage signal 202. The sum signal 206 may be subject to further processing by a signal processor 210, and the difference signal 208 may also be subject to further processing by a signal processor 212 (in a practical embodiment, both of these signal processors may be realized as a single element). The signal processors 210/212 are preferably configured to analyze characteristics of the respective sum and difference signals 206/208. As described in more detail below, sum signal 206 correlates to the first vibration state and difference signal 208 correlates to the second vibration state. Thus, signal processors 210/212 may be designed to analyze sum and difference signals 206/208 to determine the extent of vibration corresponding to the first vibration state and the extent of vibration corresponding to the second vibration state. In this regard, controller/processor 200 may include a first vibration state quantifier 214 that is configured to quantify the extent of vibration in the first state, and a second vibration state quantifier 216 that is configured to quantify the extent of vibration in the second state. The quantifiers 214/216 may produce appropriate outputs (e.g., alarm signals, display signals, control signals, or the like) for further processing as needed. In lieu of separate logical elements, these quantifiers 214 and 216 may be incorporated into the logic of signal processors 210 and 212.

Referring to FIG. 6, processor/controller 300 receives a first voltage signal 302 associated with first sensor 104, and a second voltage signal 304 associated with second sensor 106. These signals may be identical to signals 202 and 204 described above in connection with FIG. 5. A phase compare (or phase analyzer) element 305 generates an in-phase component 306 and an out-of-phase component 308 in response to its analysis of first and second voltage signals 302 and 304. Thus, phase compare element 305 may be suitably configured to compare first voltage signal 302 and second voltage signal 304 to determine in-phase component 306 and out-of-phase component 308. In this regard, in-phase component 306 may be a signal, a quantity, an identifier, or any suitable output that represents the extent that first and second voltage signals 302 and 304 are in phase with each other. Similarly, out-of-phase component 308 may be a signal, a quantity, an identifier, or any suitable output that represents the extent that first and second voltage signals 302 and 304 are out of phase with each other. The in-phase component 306 may be subject to further processing by a signal processor 310, and the out-of-phase component 308 may also be subject to further processing by a signal processor 312 (in a practical embodiment, both of these signal processors may be realized as a single element). The signal processors 310 and 312 are preferably configured to analyze characteristics of the respective in-phase and out-of-phase components 306 and 308. As described in more detail below, in-phase component 306 correlates to the first vibration state and out-of-phase signal 308 correlates to the second vibration state. Thus, signal processors 310 and 312 may be designed to analyze components 306 and 308 to determine the extent of vibration corresponding to the first vibration state and the extent of vibration corresponding to the second vibration state. In this regard, controller/processor 300 may include a first vibration state quantifier 314 that is configured to quantify the extent of vibration in the first state, and a second vibration state quantifier 316 that is configured to quantify the extent of vibration in the second state. The quantifiers 314 and 316 may produce appropriate outputs (e.g., alarm signals, display signals, control signals, or the like) for further processing as needed. In lieu of separate logical elements, these quantifiers 314 and 316 may be incorporated into the logic of signal processors 310 and 312.

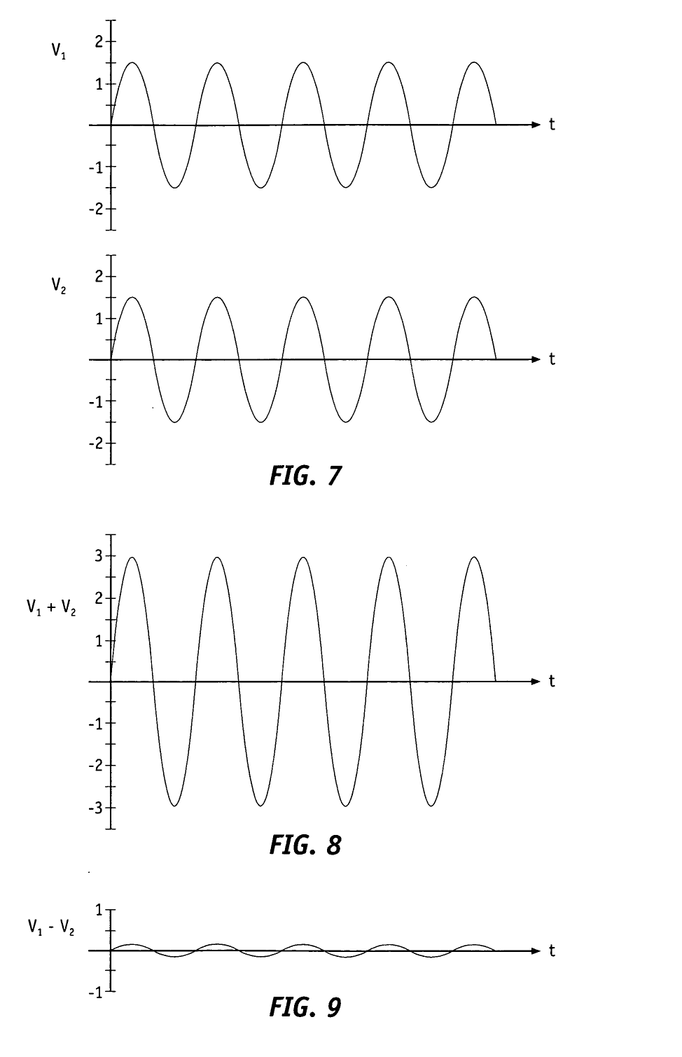

FIGS. 7-12 are graphs of sensor voltage signals and signals derived from the sensor voltage signals, where such derived signals can be processed by vibration measurement system 100 to resolve the different vibration states. These graphs merely depict simplified signals that are effective for illustrating the operation of vibration measurement system 100. In practice, the actual signal characteristics may be more complex than that shown in FIGS. 7-12.

FIG. 7 includes graphs of two example vibration sensor signals corresponding to the first vibration state depicted in FIG. 3. This direction of vibration induces an equal and symmetrical voltage response in the two sensors. Thus, the V₁ signal is virtually identical to, and in phase with, the V₂ signal in this example. FIG. 8 is a graph of a signal that represents the sum of the signals shown in FIG. 7. Notably, the sum signal is in phase with both sensor signals and the sum signal has a significant magnitude. In contrast, FIG. 9 is a graph of a signal that represents the difference (V₁−V₂) of the signals shown in FIG. 7. The difference signal is very low in magnitude relative to either of the two sensor signals because the two sensor signals are almost identical in this example.

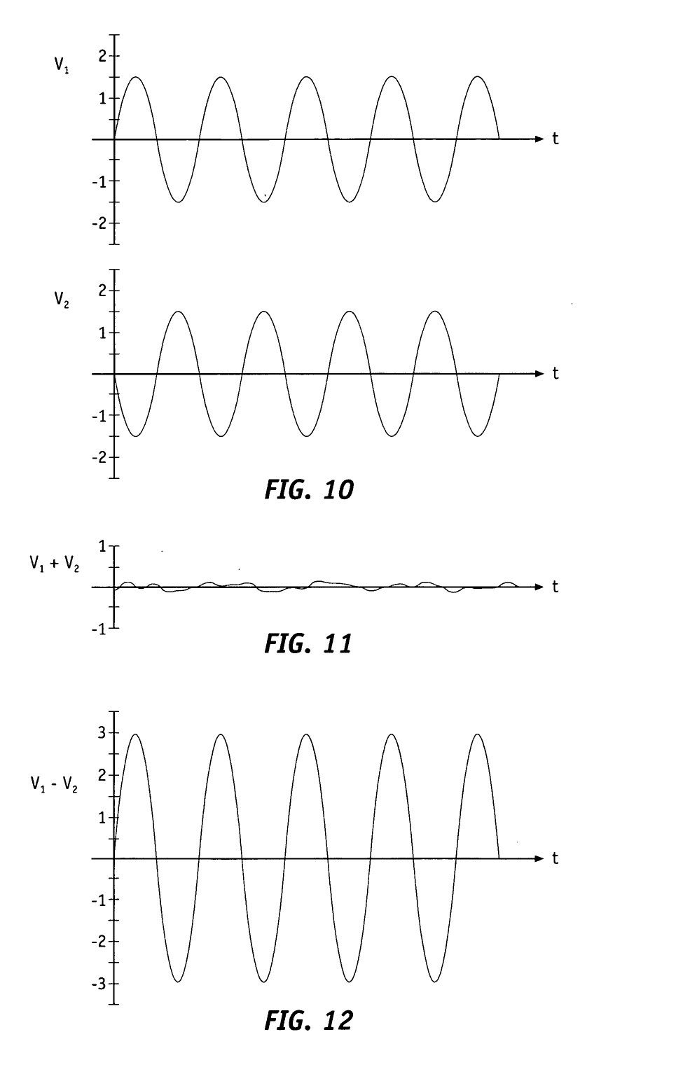

FIG. 10 includes graphs of two example vibration sensor signals corresponding to the second vibration state depicted in FIG. 4. As the magnetic element moves from the center position towards one sensor, it concurrently moves away from the other sensor. Thus, whenever one sensor is producing a positive pulse, the other sensor is producing a negative pulse. This direction of vibration induces an opposite (out-of-phase) response in the two sensors. Thus, the V₁ signal is 180 degrees out of phase with the V₂ signal in this example. FIG. 11 is a graph of a signal that represents the sum of the signals shown in FIG. 10. Here, the sum signal is very low in magnitude relative to either of the two sensor signals because the two sensor signals “cancel” each other due to their out-of-phase relationship. In contrast, FIG. 12 is a graph of a signal that represents the difference (V₁−V₂) of the sensor signals shown in FIG. 10. Notably, the difference signal is in phase with the V₁ signal and out of phase with the V₂ signal in this example, and the difference signal has a significant magnitude.

The graphs shown in FIGS. 7-12 demonstrate that the sum signal can be used as an indicator of vibration in a plane perpendicular to the imaginary line that joins the longitudinal centers of the two sensors, while the difference signal can be used as an indicator of vibration in a plane parallel to the imaginary line. Although the above simple example assumes that the magnetic element is equidistant from the two sensors, the concept can be extended to other configurations by adjusting the magnitude of the sensor signals to compensate for any positional differences prior to addition and subtraction.

In a practical application where the magnetic element is free to vibrate in more than two orthogonal directions, additional signal processing may be implemented to resolve the extent of vibration in the various directions. For example, the sum signal will remain in phase with the two sensor signals, with decreasing magnitude, as the vibration state changes from the first state to the second state. As another example, the difference signal will increase in magnitude as the vibration state changes from the first state to the second state. In addition, the frequency of the difference signal becomes half the frequency of the two sensor signals as the vibration state changes from the first state to the second state. Furthermore, the phase relationship between the two sensor signals will change from being in-phase to being out-of-phase as the vibration state changes from the first state to the second state. These and other characteristics of the sensor signals, the difference signals, and/or the sum signals can be processed by vibration measurement system 100 to quantify the directional states of vibration of the target component. For example, vibration measurement system 100 may be suitably configured to analyze a relationship between the frequency content of out-of-phase and in-phase components to differentiate between normal vibration and vibration associated with a known failure mode.

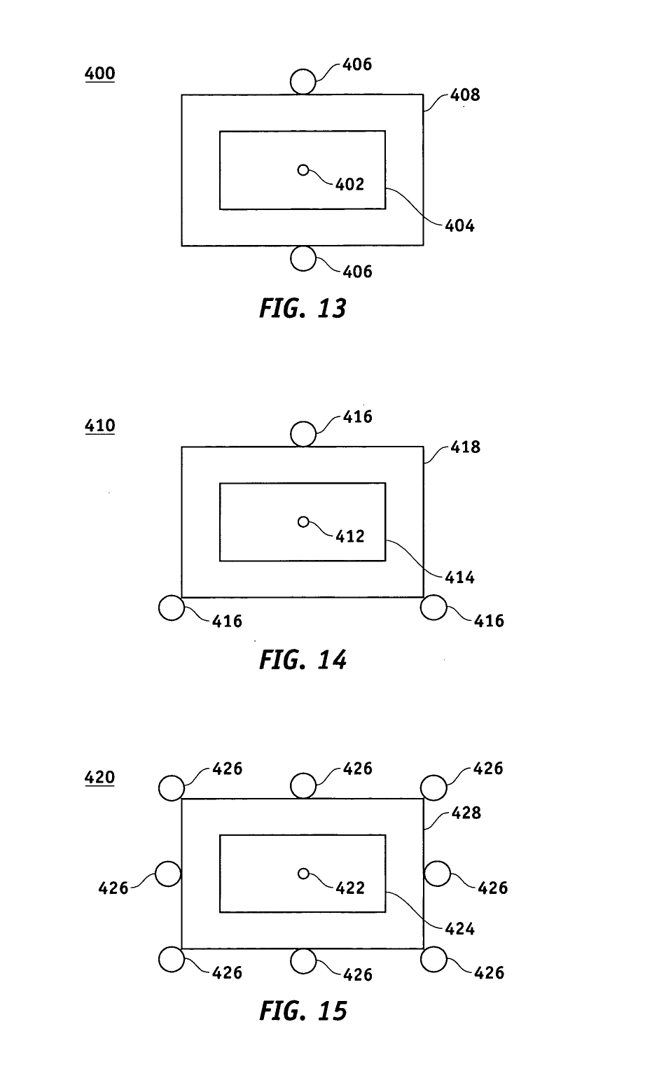

As mentioned above, the number of magnetic elements, the number of sensors, and the overall topology of vibration measurement system 100 can be modified to suit the needs of the particular application. In this regard, FIG. 13 is a schematic representation of a two-sensor vibration measurement system 400 configured in accordance with an example embodiment of the invention. System 400, which generally includes a magnetic element 402 coupled to a target component 404, and two sensors 406 coupled to a housing 408, is similar to that described above. FIG. 14 is a schematic representation of a three-sensor vibration measurement system 410 configured in accordance with another possible embodiment of the invention. System 410 generally includes a magnetic element 412 coupled to a target component 414, and three sensors 416 coupled to a housing 418. FIG. 15 is a schematic representation of an eight-sensor vibration measurement system 420 configured in accordance with yet another example embodiment of the invention. System 420 generally includes a magnetic element 422 coupled to a target component 424, and eight sensors 426 coupled to a housing 428. The alternate systems 410 and 420 may be desirable to provide enhanced measurement accuracy, obtain position information for the magnetic element, and/or to enable the measurement of more than two vibration directions. The signal processing described above may need to be modified to support systems 410/420, due to the increased number of sensor inputs.

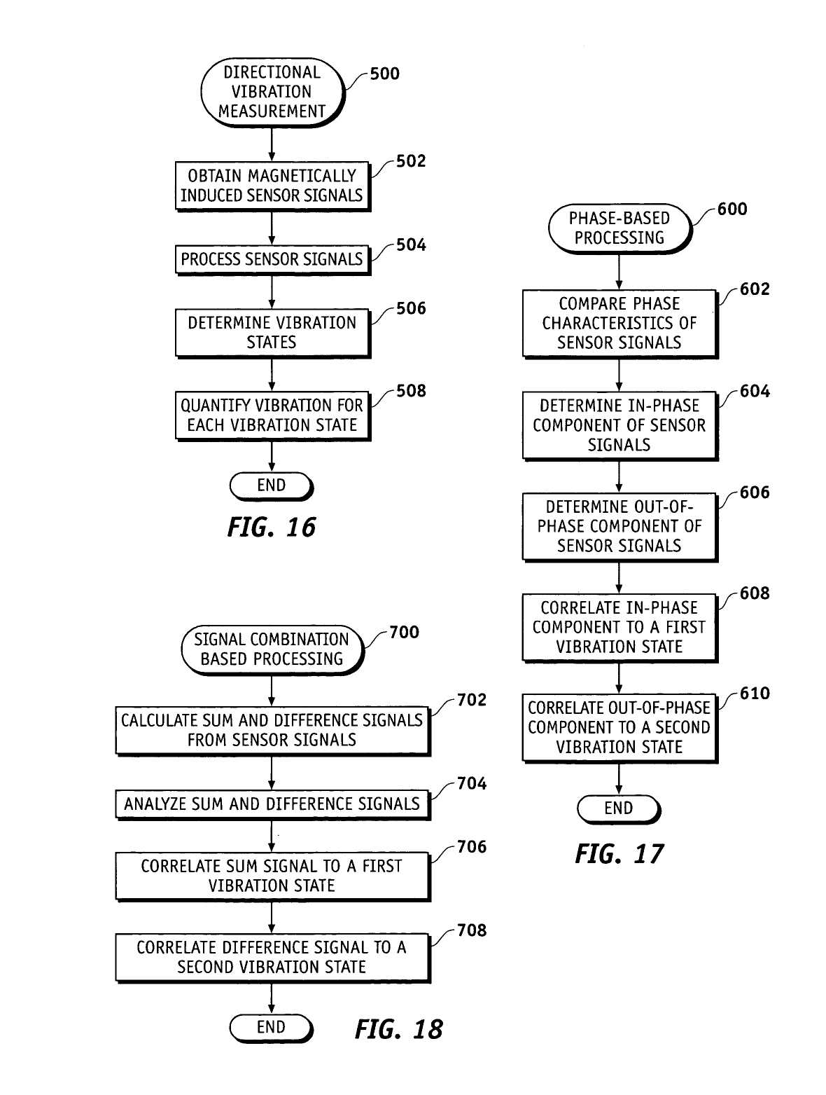

A vibration measurement system as described herein can be utilized to carry out a method for measuring the direction of vibration of a target component. In this regard, FIG. 16 is a flow chart of a directional vibration measurement process 500 according to an example embodiment of the invention. Process 500 assumes that a magnetic element as described herein has been coupled to the target component and that at least two induction coil sensors as described herein have been mounted in a fixed manner relative to the target component. As the target component (and therefore, the magnetic element) vibrates, a first sensor generates a first sensor signal in response to the vibration, and a second sensor generates a second sensor signal in response to the vibration. The various tasks performed in connection with process 500 may be performed by software, hardware, firmware, or any combination thereof. For illustrative purposes, the following description of process 500 may refer to elements mentioned above in connection with FIGS. 1-6. In practical embodiments, portions of process 500 may be performed by different elements of the described system, e.g., controller/processor 107 (see FIG. 2) or any functional subcomponent thereof. It should be appreciated that process 500 may include any number of additional or alternative tasks, the tasks shown in FIG. 16 need not be performed in the illustrated order, and process 500 may be incorporated into a more comprehensive procedure or process having additional functionality not described in detail herein.

Directional vibration measurement process 500 may begin by obtaining a plurality of magnetically induced sensor signals (task 502). As described above, these signals are generated in response to vibration of a magnetic element coupled to the vibrating component of interest. In the simple example described herein, task 502 obtains a first sensor signal and a second signal generated by respective induction coil sensors. Notably, the sensor signals may be obtained in a continuous manner by the vibration measurement system. The sensor signals are suitably processed (task 504) to determine at least a first vibration state of the target component, which corresponds to a first direction of motion, and a second vibration state of the target, which corresponds to a second direction of motion (task 506). In the simple example described herein, the first vibration state refers to the vibration shown in FIG. 3, and the second vibration state refers to the vibration shown in FIG. 4. In practical embodiments, process 500 may quantify the vibration for each vibration state (task 508). For example, process 500 may generate a vibration frequency, vibration magnitude, a warning or alarm signal if the vibration exceeds a certain threshold, or the like.

As mentioned previously, the vibration measurement system may resolve the vibration states by analyzing phase characteristics of the sensor signals. In this regard, FIG. 17 is a flow chart of phase-based processing 600 that may be performed in connection with directional vibration measurement process 500. The various tasks performed in connection with process 600 may be performed by software, hardware, firmware, or any combination thereof. For illustrative purposes, the following description of process 600 may refer to elements mentioned above in connection with FIGS. 1-6. In practical embodiments, portions of process 600 may be performed by different elements of the described system, e.g., controller/processor 107 or any functional subcomponent thereof. It should be appreciated that process 600 may include any number of additional or alternative tasks, the tasks shown in FIG. 17 need not be performed in the illustrated order, and process 600 may be incorporated into a more comprehensive procedure or process having additional functionality not described in detail herein.

Assuming that the vibration of the target component is relatively periodic, each of the obtained sensor signals will have a particular phase characteristic relative to a reference signal and/or relative to each other. Phase-based processing 600 relies on this phase relationship, and compares the phase characteristics of the sensor signals (task 602). In the simple example described above, if the vibration of the component is solely in the first vibration direction or state (see FIG. 3), then the two sensor signals will have a significant in-phase component and an insignificant out-of-phase component. In contrast, if the vibration of the component is solely in the second vibration direction or state (see FIG. 4), then the two sensor signals will have a significant out-of-phase component and an insignificant in-phase component. Thus, process 600 may determine the in-phase component of the sensor signals (task 604) and the out-of-phase component of the sensor signals (task 606) for purposes of resolving the actual vibration state(s) of the vibrating object. Process 600 may analyze the in-phase and out-of-phase components in a suitable manner that correlates the in-phase component to the first vibration state (task 608), and correlates the out-of-phase component to the second vibration state (task 610). Thus, one or more vibration states can be determined using such phase-based processing 600.

Alternatively (or additionally), the vibration measurement system may resolve the vibration states by analyzing various combinations of the sensor signals. In this regard, FIG. 18 is a flow chart of signal combination based processing 700 that may be performed in connection with directional vibration measurement process 500. The various tasks performed in connection with process 700 may be performed by software, hardware, firmware, or any combination thereof. For illustrative purposes, the following description of process 700 may refer to elements mentioned above in connection with FIGS. 1-6. In practical embodiments, portions of process 700 may be performed by different elements of the described system, e.g., controller/processor 107 or any functional subcomponent thereof. It should be appreciated that process 700 may include any number of additional or alternative tasks, the tasks shown in FIG. 18 need not be performed in the illustrated order, and process 700 may be incorporated into a more comprehensive procedure or process having additional functionality not described in detail herein.

As described in connection with the basic two-sensor example, if the vibration of the component is solely in the first vibration direction or state (see FIG. 3), then the sum of the two sensor signals will have a significant magnitude and the difference of the two sensor signals will have an insignificant magnitude. In contrast, if the vibration of the component is solely in the second vibration direction or state (see FIG. 4), then the difference of the two sensor signals will have a significant magnitude and the sum of the two sensor signals will have an insignificant magnitude. Thus, process 700 may generate or calculate sum and difference signals from the obtained sensor signals (task 702) for purposes of resolving the actual vibration state(s) of the vibrating object. In a more complex system having more than two magnetic field vibration sensors, task 702 may determine any number of sum signals and any number of difference signals based upon different combinations of the obtained sensor signals. Process 700 may analyze the sum and difference signals in a suitable manner (task 704), e.g., to obtain characteristics related to their respective magnitudes. In response to the analysis of the sum and difference signals, process 700 correlates the sum signal to the first vibration state (task 706), and correlates the difference signal to the second vibration state (task 708). Thus, one or more vibration states can be determined using such signal combination based processing 700. Moreover, in the case of multiple sensors, static component position may be accurately determined via task 704 in some situations.

In summary, a vibration measurement system as described herein is capable of measuring the direction of vibration of a target component using magnetic induction techniques. Such techniques enable the directional vibration measurement of an internal component that might be surrounded by an outer housing or is otherwise inaccessible, where the system need not mechanically or electrically conductively penetrate the outer housing.

While at least one example embodiment has been presented in the foregoing detailed description, it should be appreciated that a vast number of variations exist. For instance, the techniques and concepts described above can be extended to systems having more than two vibration sensors, systems intended to measure more than two different vibration directions, and systems that utilize more than one magnetic element coupled to the vibrating object. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for measuring directional vibration of a component, said method comprising:
obtaining a first magnetically induced sensor signal generated in response to vibration of a magnetic element coupled to the component;
obtaining a second magnetically induced sensor signal generated in response to vibration of said magnetic element; and
processing said first magnetically induced sensor signal and said second magnetically induced sensor signal to determine at least a first vibration state of the component corresponding to a first direction of motion, and a second vibration state of the component corresponding to a second direction of motion.

2. A method according to claim 1, said first magnetically induced sensor signal comprising a first voltage signal generated by a first induction coil sensor having a first fixed position relative to the component, and said second magnetically induced sensor signal comprising a second voltage signal generated by a second induction coil sensor having a second fixed position relative to the component.

3. A method according to claim 1, wherein processing said first magnetically induced sensor signal and said second magnetically induced sensor signal comprises determining a phase relationship between said first magnetically induced sensor signal and said second magnetically induced sensor signal.

4. A method according to claim 1, wherein processing said first magnetically induced sensor signal and said second magnetically induced sensor signal comprises determining an in-phase component and an out-of-phase component associated with said first magnetically induced sensor signal and said second magnetically induced sensor signal.

5. A method according to claim 4, said in-phase component correlating to said first vibration state and said out-of-phase component correlating to said second vibration state.

6. A method according to claim 1, said first magnetically induced sensor signal comprising a first voltage signal, said second magnetically induced sensor signal comprising a second voltage signal, and processing said first magnetically induced sensor signal and said second magnetically induced sensor signal comprises generating a sum and a difference of said first voltage signal and said second voltage signal.

7. A method according to claim 6, said sum correlating to said first vibration state and said difference correlating to said second vibration state.

8. A system for measuring directional vibration of a component, said system comprising:
a magnetic element coupled to the component;
a first induction coil sensor having a first fixed position relative to the component, said first induction coil sensor being configured to provide a first magnetically induced sensor signal in response to vibration of said magnetic element;
a second induction coil sensor having a second fixed position relative to the component, said second induction coil sensor being configured to provide a second magnetically induced sensor signal in response to vibration of said magnetic element; and
a processor/controller coupled to said first induction coil sensor and to said second induction coil sensor, said processor/controller being configured to process said first magnetically induced sensor signal and said second magnetically induced sensor signal to determine at least a first vibration state of the component corresponding to a first direction of motion, and a second vibration state of the component corresponding to a second direction of motion.

9. A system according to claim 8, said first magnetically induced sensor signal comprising a first voltage signal, and said second magnetically induced sensor signal comprising a second voltage signal.

10. A system according to claim 8, wherein said processor/controller is configured to determine a phase relationship between said first magnetically induced sensor signal and said second magnetically induced sensor signal.

11. A system according to claim 8, wherein said processor/controller is configured to determine an in-phase component and an out-of-phase component associated with said first magnetically induced sensor signal and said second magnetically induced sensor signal.

12. A system according to claim 11, said in-phase component correlating to said first vibration state and said out-of-phase component correlating to said second vibration state.

13. A system according to claim 8, said first magnetically induced sensor signal comprising a first voltage signal, said second magnetically induced sensor signal comprising a second voltage signal, and said processor/controller being configured to generate a sum and a difference of said first voltage signal and said second voltage signal.

14. A system according to claim 13, said sum correlating to said first vibration state and said difference correlating to said second vibration state.

15. A system according to claim 8, said magnetic element being coupled to an internal component contained within a housing, said first induction coil sensor being coupled to said housing, and said second induction coil sensor being coupled to said housing.

16. A system according to claim 8, wherein:
said magnetic element has a longitudinal axis;
said first induction coil sensor comprises a first ferromagnetic core having a first core longitudinal axis that is nominally parallel to said longitudinal axis; and
said second induction coil sensor comprises a second ferromagnetic core having a second core longitudinal axis that is nominally parallel to said longitudinal axis.

17. A system according to claim 16, wherein:
said magnetic element is located between said first induction coil sensor and said second induction coil sensor;
said first vibration state corresponds to a direction of motion perpendicular to a line or plane between said first core longitudinal axis and said second core longitudinal axis; and
said second vibration state corresponds to a direction of motion along said line or plane.

18. In a vibration measurement system comprising a magnetic element located between a first magnetic field sensor and a second magnetic field sensor, the first magnetic field sensor having a first longitudinal axis and the second magnetic field sensor having a second longitudinal axis, a method for measuring directional vibration of the magnetic element, said method comprising:
generating a first sensor signal in response to vibration of the magnetic element relative to the first magnetic field sensor;
generating a second sensor signal in response to vibration of the magnetic element relative to the second magnetic field sensor; and
processing said first sensor signal and said second sensor signal to determine at least a first vibration state of the magnetic element corresponding to a direction of motion perpendicular to a line or plane between the first longitudinal axis and the second longitudinal axis, and a second vibration state of the magnetic element corresponding to a direction of motion along said line or plane.

19. A method according to claim 18, wherein processing said first sensor signal and said second sensor signal comprises determining a phase relationship between said first sensor signal and said second sensor signal.

20. A method according to claim 18, said first sensor signal comprising a first voltage signal, said second sensor signal comprising a second voltage signal, and processing said first sensor signal and said second sensor signal comprises generating a sum and a difference of said first voltage signal and said second voltage signal, said sum correlating to said first vibration state and said difference correlating to said second vibration state.
